(19) United States
(12) Patent Application Publication
(10) Pub. No.: US 2002/0157607 A1
(43) Pub. Date: Oct. 31, 2002

(54) Method for feeding corrosion inhibitor

(76) Inventor: Junichi Nakajima, Hojo-shi (JP)

Correspondence Address: BIRCH STEWART KOLASCH & BIRCH, PO BOX 747, FALLS CHURCH, VA, 22040-0747, US

(21) Appl. No.: 10/082,066

(22) Filed: Feb. 26, 2002

(30) Foreign Application Priority Data
Feb. 27, 2001 (JP) 2001-51494

(51) Int. Cl. B05C 11/00

(52) U.S. Cl. 118/694; 118/663

(57) ABSTRACT

There is provided a method for feeding a corrosion inhibitor, that is capable of feeding a corrosion inhibitor necessary for preventing corrosion on steam lines and/or condensate lines without wasting any part thereof and is free from causing trouble of water level control. The method consists of the step of feeding a corrosion inhibitor to a steam line 3 or a condensate line 5 in a boiler system having the condensate line 5.

### BACKGROUND OF THE INVENTION

The present invention relates to a method for feeding a corrosion inhibitor to inhibit corrosion on steam lines and/or condensate lines in a boiler system having condensing lines.

Conventionally, there have been a boiler system which feeds steam from a boiler to a load device, returns the steam after heat exchange in the load device as condensate, and reuse the condensate as boiler feed water. This kind of boiler system is structured, as shown in FIG. 3, such that steam fed from a boiler 21 to a load device 23 through a steam line 22 is heat-exchanged in the load device 23, and condensate generated by heat exchange is sent to a feed water tank 25 through a condensate line 24 and mixed in the feed water tank 25 with makeup water fed from a makeup water line 26 to generate feed water to be fed to the boiler 21 through a feed water line 27.

In some cases, the steam line 22 and the condensate line 24 in the boiler system suffer from general corrosion and pitting corrosion on an area in contact with steam and condensate due to the low pH value of the condensate caused by carbon dioxide, oxidation caused by dissolved oxygen, and so on.

As a measure to prevent generation of the general corrosion and pitting corrosion, there is generally adopted a chemical treatment. The chemical treatment is performed by methods using corrosion inhibitors including a method using film-type anticorrosives to prevent corrosion on metal lines by forming a film thereon, and a method using neutralizing-type anticorrosives to prevent corrosion on lines by neutralizing acid.

The chemical treatment will be herein described with reference to FIG. 3. First, a corrosion inhibitor is typically fed with use of a chemical feeder 28 to the feed water line 27 that feeds water from the feed water tank 25 to the boiler 21. What causes a problem here is that the corrosion inhibitor is distributed inside the boiler 21 to steam and boiler water. It means that not all part of the corrosion inhibitor fed to prevent corrosion on the steam line 22 and the condensate line 24 flows into the steam line 22 and the condensate line 24, but part thereof remains in the boiler water, thereby generating the existence of a corrosion inhibitor uninvolved in corrosion prevention of the steam line 22 and the condensate line 24. Consequently, feeding a corrosion inhibitor to the boiler feed water allowing part thereof remaining in the boiler water requires a large amount of dosage.

Furthermore, there have been reported cases where use of film-type anticorrosives causes trouble of water level control, since a film is formed on a water-level electrode (unshown) for controlling the water level inside the boiler 21.

### SUMMARY OF THE INVENTION

In view of the above-mentioned problem, it is an object of the present invention to provide a method for feeding a corrosion inhibitor, that is capable of feeding a corrosion inhibitor necessary for preventing corrosion on steam lines and/or condensate lines without wasting any part thereof and is free from causing trouble of water level control.

The present invention was invented to solve the above-mentioned problem. In one aspect of the present invention, a corrosion inhibitor is fed to a steam line or a condensate line in a boiler system having condensate lines.

In another aspect of the present invention, a corrosion inhibitor is fed to a steam header provided in the steam line.

### BRIEF DESCRIPTION OF THE DRAWINGS

FIG. 1 is a schematic view showing a first embodiment of the present invention;

FIG. 2 is a schematic view showing a second embodiment of the present invention; and

FIG. 3 is a schematic view showing a prior art method for feeding a corrosion inhibitor.

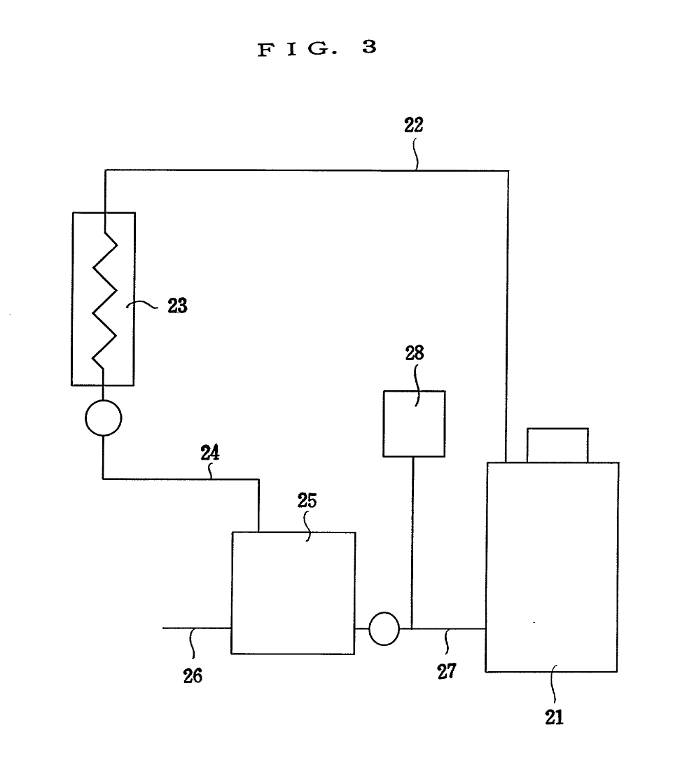

### DETAILED DESCRIPTION OF THE PREFERRED EMBODIMENTS

The embodiments of the present invention will be described hereinafter. The present invention is preferably applicable to corrosion prevention of steam lines and/or condensate lines in a boiler system that has condensate lines for a steam boiler or the like. The present invention relates to feeding of a corrosion inhibitor to steam lines or condensate lines.

Description will first be given of a steam line. When a boiler is operating, the steam line is normally filled with steam, and therefore less likely to be corroded. However, when the boiler operation is stopped, the temperature of the steam line is dropped, and so the steam in the steam line condenses to become water. Carbon dioxide dissolved in the condensed water creates acid, which causes corrosion due to low pH.

Next, a condensate line will be described. The condensate line is equipped with a steam trap, which separates water and steam used and condensed in the load device and discharges the water only. When carbon dioxide or other elements are dissolved in the condensed water, acid is generated, which causes corrosion due to low pH.

Accordingly, in order to prevent corrosion caused by the acid, feeding of a corrosion inhibitor is performed. The corrosion inhibitor includes a film-type anticorrosive that prevents corrosion by forming a film on the steam line and the condensate line, a neutralizing-type anticorrosive that prevents corrosion by neutralizing acid contained in steam and condensate, and a complex-type anticorrosive formed by combining the film-type anticorrosive and the neutralizing-type anticorrosive.

Prevention of corrosion on the steam line and the condensate line is achieved with use of the corrosion inhibitor. Feeding position of the corrosion inhibitor is preferably on the upstream side of the steam line. In the boiler system having a steam header, feeding is preferably made to the steam header.

Description will first be made of the case where the corrosion inhibitor is fed on the upstream side of the steam line. The steam line is susceptible to corrosion caused by acid. More particularly, corrosion is generated in an area with the presence of steam containing carbon dioxide when the steam is condensed. Consequently, feeding the corrosion inhibitor at the first position where the steam passes would control corrosion on the steam line and all the lines on the downstream thereof. Therefore, for controlling corrosion on all the lines after the steam line, it is preferable to feed the corrosion inhibitor as upstream as possible.

The primary advantage of feeding the corrosion inhibitor on the upstream side of the steam line includes ability to prevent corrosion of all the lines after the steam line. This means that corrosion of the steam line and the condensate line can be prevented. In addition, since the corrosion inhibitor is fed to the steam line, there is no chance of causing trouble with water level control in a boiler due to formation of a film on a water level electrode. Further, feeding the corrosion inhibitor to the steam line makes it possible to use all part of the corrosion inhibitor to be fed as a corrosion inhibiting ingredient, enabling feeding of the corrosion inhibitor in response to an amount of evaporation in the boiler. This enables feeding of an adequate amount of the corrosion inhibitor conforming to an amount of evaporation, thereby preventing overdosage of the corrosion inhibitor.

Description will now be given of the case of feeding the corrosion inhibitor to the steam header. The steam header is a device to collect steam from a single or a plurality of boilers and feed it to a single or a plurality of load devices. More particularly, steam generated in each boiler is collected in the steam header. Consequently, feeding the corrosion inhibitor to the steam header enables overall control of corrosion on each steam line used to feed steam from the steam header to a plurality of the load devices. In addition, corrosion on the condensate line located after the load devices is also prevented at the same time.

The primary advantage of feeding the corrosion inhibitor to the steam header includes ability of overall prevention of corrosion on the steam line from the steam header to the feed water tank as well as the condensate line. Therefore, one chemical feeder provided on the steam header makes it possible to prevent corrosion of all the lines to the feed water tank, thereby implementing decrease in the number of chemical feeders. In addition, since the corrosion inhibitor is fed to the steam header, there is no chance of causing trouble with water level control in a boiler due to formation of a film on a water level electrode. Further, feeding the corrosion inhibitor to the steam header makes it possible to use all part of the corrosion inhibitor to be fed as a corrosion inhibiting ingredient, enabling feeding of the amount of the corrosion inhibitor in response to the rate of steam through the steam header. This enables feeding of the adequate of amount of the corrosion inhibitor conforming to an amount of evaporation, thereby preventing overdosage of the corrosion inhibitor.

Other than the above, there is a method for feeding the corrosion inhibitor to the steam line that feeds steam from the steam header to the load device. In this method, a chemical feeder is provided on each steam line provided from the steam header to the load device, and feeding of the corrosion inhibitor is performed per line. This method is also capable of preventing corrosion on the steam line and the condensate line. In addition, it is also possible to eliminate possibility of causing trouble with water level control in a boiler due to formation of a film on a water level electrode. Further, feeding the corrosion inhibitor to all the steam lines enables use of all part of the corrosion inhibitor to be fed as a corrosion inhibiting ingredient. Further, enabling individual feeding of the amount of the corrosion inhibitor based on an amount of evaporation in each load device makes it possible to prevent overdosage of the corrosion inhibitor.

Further, there is a method for feeding the corrosion inhibitor in the condensate line located after the load device. In this method, feeding of the corrosion inhibitor particularly on the downstream side of the steam trap enables use of a nonvolatile corrosion inhibitor. This is because steam is changed to water by the steam trap and therefore volatility is not necessary for the corrosion inhibitor. This method is also capable of preventing corrosion on the condensate line. In addition, it is also possible to eliminate possibility of causing trouble with water level control in a boiler due to formation of a film on a water level electrode. Further, feeding the corrosion inhibitor to all the condensate lines enables use of all part of the corrosion inhibitor to be fed as a corrosion inhibiting ingredient. Further, enabling individual feeding of an adequate amount of the corrosion inhibitor based on an amount of evaporation in each load device makes it possible to prevent overdosage of the corrosion inhibitor.

In view of the forgoing, according to the present invention, a corrosion inhibitor necessary for preventing corrosion on steam lines and/or condensate lines can be fed without wasting any part thereof and trouble of water level control in a boiler can be prevented in advance. In the case of feeding the corrosion inhibitor to the steam header, the number of the chemical feeders can be decreased.

### (Embodiments)

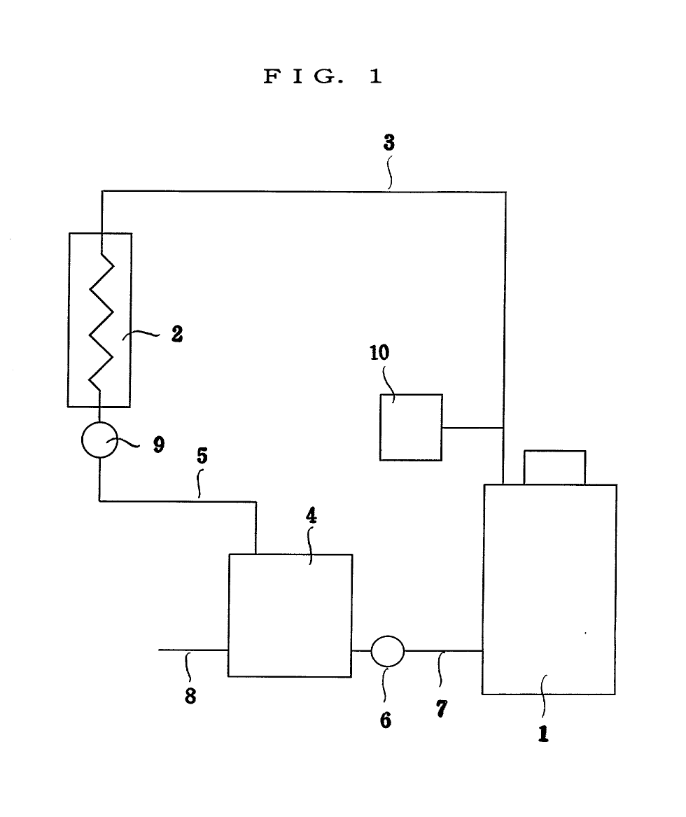

Description will now be made of specific embodiments of the present invention. FIG. 1 is a schematic view showing the outlined structure of the present invention according to the first embodiment. This is just an illustrative example of the present invention and does not limit the scope of the invention by any means.

First, in FIG. 1, a boiler 1 and a load device 2 are connected via a steam line 3, while the load device 2 and a feed water tank 4 are connected via a condensate line 5, and the feed water tank 4 and the lower parts of the boiler 1 are connected via a feed water line 7 equipped with a feed water pump 6. Also, inside the feed water tank 4, makeup water fed from a makeup water line 8 is mixed with condensate fed from the condensate line 5. The condensate line 5 is provided with a steam trap 9. In the steam trap 9, steam and water are separated, and only water is discharged. Feeding of the corrosion inhibitor in the present invention is made to the steam line 3 with use of a chemical feeder 10. Here, the feeding position of the corrosion inhibitor to the steam line 3 is preferably on the upstream side of the steam line 3. Feeding the corrosion inhibitor as upstream as possible implements better control of corrosion on the entire steam line 3 and condensate line 5.

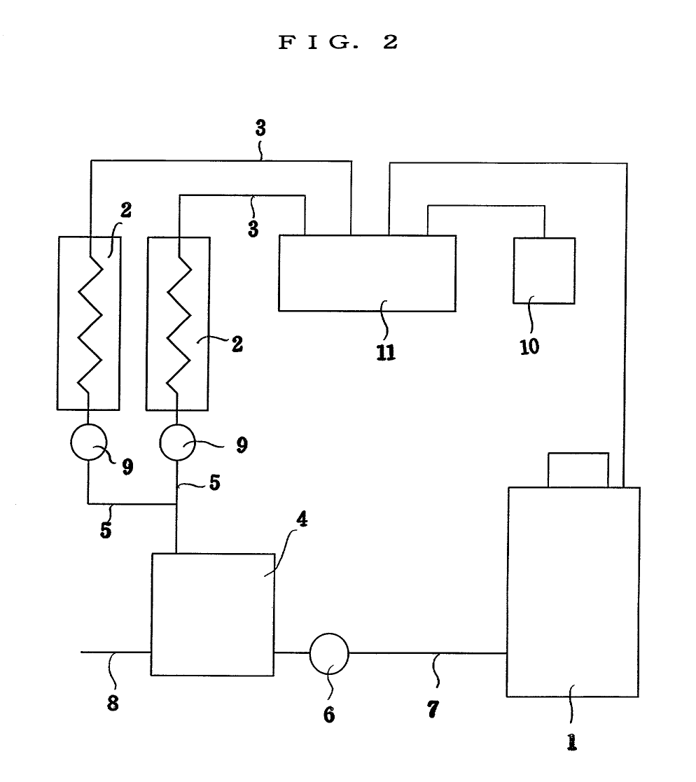

Next, description will be made of a second embodiment of the present invention with reference to FIG. 2. FIG. 2 is a schematic view showing the outlined structure of the present invention according the second embodiment, where the steam line 3 of the first embodiment is provided with a steam header 11. In the case of providing the steam header 11, the corrosion inhibitor is fed to the steam header 11 with use of the chemical feeder 10. In the case where steam is fed to a plurality of load devices 2, 2, . . . . in a distributing manner, the chemical feeder 10 is not necessary to be put on steam lines 3, 3, that feed steam to each of the load devices 2, thereby decreasing the number of the chemical feeder 10.

If a type of the corrosion inhibitor is required to be changed corresponding to each application of the load devices 2, each of the steam lines 3 that feeds steam from the steam header 11 to each of the load device 2 may be provided with the chemical feeder 10 corresponding to the application.

Following description discusses the case of feeding the corrosion inhibitor to the condensate line 5. The steam trap 9, which is provided on the condensate line 5, separated water and steam, as a result of which only water is discharged. Consequently, a downstream of the steam trap 9 consists of condensate. In FIG. 1 showing the first embodiment, feeding is preferably made immediately after the steam trap 9, whereas in FIG. 2 showing the second embodiment, feeding is preferably made immediately after each of the steam trap 9. Particularly, providing the chemical feeder 10 on each downstream of the steam trap 9 enables use of a nonvolatile corrosion inhibitor, providing a wider selection range of corrosion inhibitors.

Next, description will be given of first and second experimental examples regarding corrosion inhibitor effect.

### First Example

Soft water was fed to a once-through boiler having evaporation of 500kg/h, which was run with pressure of 8Kg/cm² being given for continuous generation of steam. As a corrosion inhibitor, 2- amino-2- methyl-1- propanol was fed to a steam line for 100 mg/liter (per 1 liter of feed water); (a corrosion inhibitor of 100 mg was fed to every 1 liter feed water in the steam line). At this time, a test piece (soft steel of 50 mm ×25 mm ×1 mm) was dipped in condensate and a corrosion rate (mdd) in 48 hours was measured. The result is shown in Table 1. Water used as the feed water here was softened tap water of Matsuyama City, Ehime Pref. The water quality thereof was pH:8.1, electrical conductivity: 250 μs/cm, and M alkalinity: 50 mg CaCO₃/liter.

### Second Example

Soft water was fed to a once-through boiler having evaporation of 500 kg/h, which was run with pressure of 8Kg/cm² being given for continuous generation of steam. As a corrosion inhibitor, 2- amino-2- methyl-1- propanol was fed to a steam header for 100 mg/liter (per 1 liter of feed water); (a corrosion inhibitor of 100 mg was fed to every 1 liter feed water in the steam header). At this time, a test piece (soft steel of 50 mm ×25 mm ×1 mm) was dipped in condensate and a corrosion rate (mdd) in 48 hours was measured. The result is shown in Table 1. Water used as the feed water here was softened tap water of Matsuyama City, Ehime Pref. The water quality thereof was pH:8.1, electrical conductivity: 250 μs/cm, and M alkalinity: 50 mg CaCO₃/liter.

### Comparative Example

There was fed soft water with 2- amino-2- methyl-1- propanol being fed for 100 mg/liter (per 1 liter of feed water) to a once-through boiler having evaporation of 500 kg/h, which was run with pressure of 8Kg/cm² being given for continuous generation of steam. At this time, a test piece (soft steel of 50 mm ×25 mm ×1 mm) was dipped in condensate and a corrosion rate (mdd) in 48 hours was measured. The result is shown in Table 1. Water used as the feed water here was softened tap water of Matsuyama City, Ehime Pref. The water quality thereof was pH:8.1, electrical conductivity: 250 μs/cm, and M alkalinity: 50 mg CaCO₃/liter.

TABLE 1

| | Dosage of corrosion | |
|---|---|---|
| | inhibitor (mg/kg in | Corrosion rate |
| | steam or feed water) | (mdd) |
| First example | 100 | 11 |
| Second example | 100 | 12 |
| Comparative | 100 | 30 |
| example | | |

As is clear from Table 1, feeding 2- amino-2-methyl-1- propanol to feed water provides a larger corrosion rate and smaller corrosion inhibiting effect than feeding it to the steam line. Generally, a proportion of distributing 2- amino-2- methyl-1- propanol to steam and water in a boiler is approximately 37: 63. As a consequence, an amount of the corrosion inhibitor implementing corrosion inhibiting effect in the steam line and condensate line drops by 63% from an amount of the corrosion inhibitor fed in the first place. This decreases corrosion inhibiting effect and increases the corrosion rate. In other words, feeding the corrosion inhibitor to the steam line provides the same corrosion inhibiting effect with a dosage approximately 63% smaller than that of the corrosion inhibitor fed to feed water. Also, if the corrosion inhibitor used in the first and second embodiments is a film-type anticorrosive such as octadecylamine, feeding the corrosion inhibitor to the steam line makes it possible to eliminate trouble of water level control in a boiler caused by forming a film on a water level electrode. Further, in the case of feeding the corrosion inhibitor to the steam header as shown in the second embodiment, only one chemical feeder is required to be provided, thereby enabling decrease in the number of chemical feeders.

As described above, according to the present invention; it is possible to provide a method for feeding a corrosion inhibitor, that is capable of feeding a corrosion inhibitor necessary for preventing corrosion on steam lines and/or condensate lines without wasting any part thereof and is free from causing trouble of water level control.

What is claimed is:

1. A method for feeding a corrosion inhibitor, comprising the step of feeding a corrosion inhibitor to a steam line 3 or a condensate line 5 in a boiler system having the condensate line 5.

2. The method for feeding a corrosion inhibitor as defined in claim 1, comprising the step of feeding a corrosion inhibitor to a steam header 11 provided on the steam line 3.
